(19) United States
(12) Patent Application Publication
(10) Pub. No.: US 2014/0364308 A1
(43) Pub. Date: Dec. 11, 2014

(54) MICROCAPSULE CONTAINING FUNGICIDAL ACTIVE INGREDIENT

(71) Applicant: SUMITOMO CHEMICAL COMPANY, LIMITED, Tokyo (JP)

(72) Inventors: Takuya Tanaka, Takarazuka-shi (JP); Nobuhito Ueda, Takarazuka-shi (JP)

(21) Appl. No.: 14/363,702

(22) PCT Filed: Dec. 20, 2012
(86) PCT No.: PCT/JP2012/084010

§ 371 Date: Jun. 6, 2014

(30) Foreign Application Priority Data
Dec. 27, 2011 (JP) 2011-284974

(51) Int. Cl. A01N 25/28; A01N 43/653

(52) U.S. Cl. CPC A01N 25/28; A01N 43/653
USPC 504/100; 424/419; 514/383

(57) ABSTRACT

There is provided a microcapsule for plant disease control in which a core material containing a fungicidal active ingredient is enclosed within a shell material; wherein the microcapsule satisfies the following conditions (1) and (2), is a formulation that withstands physical impacts, drying and diluting, and is suitable for seed treatment using a stirring type machine, and the durability of control of diseases of crops and the safety for the crops can be improved more efficiently by the microcapsule of the present invention; Condition (1): D₅₀/T≦230; Condition (2): (D₉₀−D₁₀)/D₅₀≦2.5; and wherein in the formulae of conditions (1) and (2), T represents the shell thickness (μm) of the microcapsule, and D₁₀, D₅₀ and D₉₀ respectively represent the 10%, 50% and 90% cumulative volume particle diameter (μm) of the microcapsule.

### TECHNICAL FIELD

The present invention relates to a microcapsule containing fungicidal active ingredients.

### BACKGROUND ART

Various plant disease controlling agents containing fungicidal active ingredients have heretofore been known and microcapsules containing a fungicidal active ingredient as a plant disease controlling agent have been known in patent documents 1 and 2.

### PRIOR ART DOCUMENTS

### Patent Documents

Patent Document 1: JP-A-2005-170956

Patent Document 2: JP-A-2007-186497

### SUMMARY OF THE INVENTION

### Problems to be Solved by the Invention

The present inventors studied to discover a method for controlling diseases of crops efficiently and they thought to make microcapsules containing a fungicidal active ingredient to attach to a seed of a crop.

For example, a method using a stirring type machine has been known as the method of making a pesticidal active ingredient to attach to a seed of a crop. This method is useful because a large amount of seeds can be treated with a small amount of pesticidal active ingredient, but the method has a problem that seeds to which microcapsules maintaining the shape thereof attach sufficiently cannot be obtained when attempting to produce microcapsule-attached seeds by using a stirring type machine because a seed under stirring undergoes a collision with the wall of a container or with other seeds, so that a physical impact is added to the seed, and because a drying load is also added.

### Means for Solving the Problems

As a result of studies in view of such situations, the present inventors have accomplished the present invention by finding that microcapsules satisfying certain conditions withstand a physical impact from a stirring type machine, a drying load, so that the seed can be attached efficiently to seeds by using a stirring type machine. The invention will be described below.

[1] A microcapsule in which a core material containing a fungicidal active ingredient is enclosed within a shell material, wherein the microcapsule satisfies the following conditions (1) and (2):

D₅₀/T≦230 condition (1)

(D₉₀−D₁₀)/D₅₀≦2.5 condition (2)

wherein in the formulae of conditions (1) and (2), T represents the shell thickness (μm) of the microcapsule, D₁₀ represents the 10% cumulative volume particle diameter (μm) of the microcapsule, D₅₀ represents the 50% cumulative volume particle diameter (μm) of the microcapsule, and D₉₀ represents the 90% cumulative volume particle diameter (μm) of the microcapsule.
[2] The microcapsule according to the above-described [1], wherein the fungicidal active ingredient is an azole compound.
[3] The microcapsule according to the above-described [1], wherein the fungicidal active ingredient is tebuconazole.
[4] The microcapsule according to any one of the above-described [1] to [3], wherein the shell material is composed of a polyurethane resin and/or a polyurea resin.
[5] The microcapsule according to any one of the above-described [1] to [4], wherein the core material contains a hydrophobic liquid.
[6] The microcapsule according to the above-mentioned [5], wherein the fungicidal active ingredient is dissolved in the hydrophobic liquid.
[7] The microcapsule according to the above-described [5], wherein the fungicidal active ingredient is dispersed in the hydrophobic liquid.
[8] The microcapsule according to the above-described [1] through [7], wherein the condition (2) is (D₉₀−D₁₀)/D₅₀≦2.1.
[9] An aqueous suspension composition in which the microcapsule according to any one of the above-described [1] through [8] is suspended in water.
[10] A method for controlling plant disease, comprising applying the microcapsule according to any one of the above-described [1] through [8] to a plant or a soil in which a plant grows.
[11] A method for controlling plant disease, comprising treating the microcapsule according to any one of the above-described [1] through [8] to a seed of a plant.
[12] A seed with the microcapsule according to any one of the above-described [1] through [8] attaching thereto.
[13] A method for controlling plant disease, comprising the step of making the microcapsule according to any one of the above-described [1] through [8] to attach to seeds of a plant before sowing the seeds.
[14] A method for producing a microcapsule-attached seed, comprising the step of treating the microcapsule according to any one of the above-mentioned [1] through [8] to a seed.

### Effect of the Invention

The microcapsule of the present invention is a suitable formulation for the seed treatment because it can be made to attach to seeds of crops efficiently by using a stirring type machine and hold therein. Further, the aqueous suspension composition of the present invention can withstand dilution when the composition is diluted with water.

By growing a seed of a crop to which microcapsules of the present invention have attached and held, diseases of the crop can be controlled for a long time without significant phytotoxicity to the crop.

### MODE FOR CARRYING OUT THE INVENTION

The microcapsule of the present, invention comprises a shell material and a core material and the shell material encloses the core material.

The core material contains a fungicidal active ingredient. Examples of the fungicidal active ingredient include, but are not limited to, benzimidazole compounds such as benomyl, carbendazim, thiabendazole and thiophanate-methyl; phenyl carbamate compounds such as diethofencarb; dicarboximide compounds such as procymidone, iprodione and vinclozolin; azole compounds such as diniconazole, probenazole, epoxiconazole, tebuconazole, metconazole, difenoconazole, cyproconazole, flusilazole and triadimefon; acylalanine compounds such as metalaxyl; carboxamide compounds such as furametpyr, mepronil, flutolanil and trifluzamide; organophosphorus compounds such as tolclofos-methyl, fosetyl-aluminum and pyrazophos; anilinopyrimidine compounds such as pyrimethanil, mepanipyrim and cyprodinil; cyanopyrrole compounds such as fludioxonil and fenpiclonil; thiazole carboxamide compounds such as ethaboxam; chlorothalonil, mancozeb, captan, folpet, tricyclazole, pyroquilon, phthalide, cymoxanil, dimethomorph, famoxadone, oxolinic acid and its salts, fluazinam, ferimzone, diclocymet, chlobenthiazone, isovaledione, tetrachloroisophthalonitrile, thiophthalimideoxybisphenoxyarsine, 3-iodo-2-propynyl butyl carbamate, and mixtures thereof.

The microcapsule of the present invention contains a fungicidal active ingredient usually in 1 to 99% by weight, preferably in 2 to 50% by weight.

The microcapsule of the present invention satisfies the following conditions (1) and (2):

D₅₀/T≦230 condition (1)

(D₉₀−D₁₀)/D₅₀≦2.5 condition (2)

wherein in the formulae of conditions (1) and (2), T represents the shell thickness (i.e. the thickness of the shell material) (μm) of the microcapsule, D₁₀ represents the 10% cumulative volume particle diameter (μm) of the microcapsule, D₅₀ represents the 50% cumulative volume particle diameter (μm) of the microcapsule, and D₉₀ represents the 90% cumulative volume particle diameter (μm) of the microcapsule.

Concerning the condition (2), “(D₉₀−D₁₀)/D₅₀≦2.3” is preferable, and “(D₉₀−D₁₀)/D₅₀≦2.1” is more preferable.

The lower limit of D₅₀/T in the microcapsule of the present invention is about 25, and the lower limit of (D₉₀−D₁₀)/D₅₀ is about 0.5.

The shell thickness (T) of the microcapsule of the present invention can be determined from the volume ratio of the core material and the shell material of the microcapsule and can be calculated by the following formula:

T=(Ww/Wc)×(ρc/ρw)×(D_{C50}/6)

Wc: the weight (g) of the core material of the microcapsule

Ww: the weight (g) of the shell material

ρc: the density (g/cm³) of the core material

ρw: the density (g/cm³) of the shell material

D_{C50}: the 50% cumulative volume particle diameter (μm) of the core material.

All shell thicknesses of microcapsules in the present invention are calculated using this formula.

The shell thickness of the microcapsule of the present invention is usually 0.001 to 1 (μm).

The shell thickness of a microcapsule can also be measured by embedding the microcapsule into resin that is incompatible with the shell material of the microcapsule, making a cross section of the microcapsule using a microtome, and then observing it with an electron microscope.

In the present invention, a 10% cumulative volume particle diameter, a 50% cumulative volume particle diameter, and a 90% cumulative volume particle diameter are values determined as follows.

First, the whole volume of an aggregate of particles is considered as being 100%. A particle diameter is measured for each particle of the aggregate and the volumes of the particles are cumulated in the order of increasing particle diameter. A particle diameter at a time when a prescribed ratio (X %) to the whole volume is achieved is defined as an X % cumulative volume particle diameter. That is, the particle diameters of particles at times when the volumes of the particles cumulated in the order of increasing particle diameter have reached 10%, 50%, and 90% are a 10% cumulative volume particle diameter, a 50% cumulative volume particle diameter, and a 90% cumulative volume particle diameter, respectively.

Volume particle diameter in the present invention is measured using a laser diffraction type particle size distribution analyzer. Examples of commercially available laser diffraction type particle size distribution analyzers include Mastersizer 2000 (manufactured by Sysmex Corp.), SALD-2000 (manufactured by Shimadzu Corporation), and Microtrac MT3000 (manufactured by Nikkiso Co., Ltd.).

The microcapsule of the present invention usually has a 10% cumulative volume particle diameter of 0.1 to 25 μm, a 50% cumulative volume particle diameter of 1 to 50 μm, and a 90% cumulative volume particle diameter of 2 to 100 μm.

When the fungicidal active ingredient contained in the microcapsule of the present invention is liquid, the core material may contain only the fungicidal active ingredient, but it may contain a hydrophobic liquid as needed. The hydrophobic liquid is selected appropriately from among those capable of dissolving the fungicidal active ingredient or those capable of dissolving the fungicidal active ingredient slightly but dispersing it depending upon the type of the fungicidal active ingredient; examples thereof include aromatic hydrocarbons, aliphatic hydrocarbons, alcohols, ketones, esters, ethers, amides, mineral oils, and vegetable oils. Examples of the aromatic hydrocarbons include toluene, xylene, alkylbenzenes, phenylxylylethane, and mixtures thereof. A commercially available solvent may be used as received as an aromatic hydrocarbon, and examples of such a commercially available solvent include Hisol SAS-296 (mixture of 1-phenyl-1-xylylethane and 1-phenyl-1-ethylphenylethane, produced by Nippon Oil Co., Ltd.), Cactus Solvent HP-MN (containing 80% methylnaphthalene, produced by Nikko Petrochemicals Co., Ltd.), Cactus Solvent HP-DMN (containing 80% dimethylnaphthalene, produced by Nikko Petrochemicals Co., Ltd.), Cactus Solvent P-100 (C9-10 alkylbenzenes, produced by Nikko Petrochemicals Co., Ltd.), Cactus Solvent P-150 (alkylbenzenes, produced by Nikko Petrochemicals Co., Ltd.), Cactus Solvent P-180 (mixture of methylnaphthalene and dimethylnaphtalene, produced by Nikko Petrochemicals Co., Ltd.), Cactus Solvent P-200 (mixture of methylnaphthalene and dimethylnaphtalene, produced by Nikko Petrochemicals Co., Ltd.), Cactus Solvent P-220 (mixture of methylnaphthalene and dimethylnaphtalene, produced by Nikko Petrochemicals Co., Ltd.), Cactus Solvent PAD-1 (dimethylmonoisopropylnaphthalene, produced by Nikko Petrochemicals Co., Ltd.), Solvesso 100 (aromatic hydrocarbons, produced by ExxonMobil Chemical), Solvesso 150 (aromatic hydrocarbons, produced by ExxonMobil Chemical), Solvesso 150ND (aromatic hydrocarbons, produced by ExxonMobil Chemical), Solvesso 200 (aromatic hydrocarbons, produced by ExxonMobil Chemical), Solvesso 200ND (aromatic hydrocarbons, produced by ExxonMobil Chemical), Swasol 100 (toluene, produced by Maruzen Petrochemical Co., Ltd.), Swasol 200 (xylene, produced by Maruzen Petrochemical Co., Ltd.). Examples of the aliphatic hydrocarbons include paraffins and olefins and a commercially available solvent can be used as received. Examples of such a commercially available solvent include Isopar H (isoparaffin, produced by ExxonMobil Chemical), MORESCO WHITE P-40 (liquid paraffin, produced by MORESCO Corporation), MORESCO WHITE P-70 (liquid paraffin, produced by MORESCO Corporation), and LINEALENE 8 (α-olefin, produced by Idemitsu Kosan Co., Ltd.). Examples of the esters include fatty acid esters and a commercially available solvent can be used as received. Examples of such a commercially available solvent include Ricsizer C-101 (castor oil fatty acid ester, produced by Itoh Oil Chemicals Co., Ltd.), Ricsizer C-88 (vegetable oil fatty acid ester, produced by Itoh Oil Chemicals Co., Ltd.), Ricsizer C-401 (castor oil fatty acid ester, produced by Itoh Oil Chemicals Co., Ltd.), Ricsizer S-8 (castor oil dibasic acid ester, produced by Itoh Oil Chemicals Co., Ltd.), Stepan C-25 (mixture of methyl caprylate and methyl caprate, produced by Stepan Company), Stepan C-42 (mixture of methyl myristate and methyl laurate, produced by Stepan Company), Stepan C-65 (mixture of methyl palmitate and methyl oleate, produced by Stepan Company), Steposol ME (mixture of methyl oleate and methyl linoleate, produced by Stepan Company), Steposol ROE-W (canola oil methyl ester, produced by Stepan Company). Examples of amides include Hallcomid M-8-10 (mixture of N, N-dimethyloctamide and N,N-dimethyldecanamide, produced by Stepan Company) and Hallcomid M-10 (N,N-dimethyldecanamide, produced by Stepan Company). Examples of the vegetable oils include soybean oil, olive oil, linseed oil, cotton seed oil, rapeseed oil, and castor oil.

When the core material contains a hydrophobic liquid, the core material contains a fungicidal active ingredient in a content usually within the range of 1 to 50% by weight, preferably 10 to 50% by weight.

Examples of the shell material forming the shell of the microcapsule of the present invention include resins such as polyurethane resin, polyurea resin, polyamide resin, polyester resin, urea formaldehyde resin, melamine formaldehyde resin, and phenol formaldehyde resin. The polyurethane resin or the polyurea resin to be used in the present invention is a resin produced by the reaction of a polyisocyanate compound with a polyol compound or a polyamine compound. The polyamide resin is a resin produced by the reaction of a polyamine compound with a polybasic acid halide compound. The polyester resin is a resin produced by the reaction of a polyhydric phenol compound with a polybasic acid halide compound. The urea formaldehyde resin is a resin produced by the reaction of urea with formaldehyde. The melamine formaldehyde resin is a resin produced by the reaction of melamine with formaldehyde. The phenol formaldehyde resin is a resin produced by the reaction of phenol with formaldehyde.

Among these resins, a shell material capable of forming a shell by an interfacial polymerization method at the interface between a core material and water is preferred, and a shell material of polyurethane resin and/or polyurea resin is more preferred.

Examples of the polyisocyanate compound include tolylene diisocyanate, hexamethylene diisocyanate, an adduct of tolylene diisocyanate and trimethylolpropane, an adduct of hexamethylene diisocyanate and trimethylolpropane, an isocyanurate condensate of tolylene diisocyanate, an isocyanurate condensate of hexamethylene diisocyanate, a biuret condensate of three molecules of hexamethylene diisocyanate, an isocyanate prepolymer in which one of the isocyanate groups of hexamethylene diisocyanate has formed an isocyanurate form together with two molecules of tolylene diisocyanate and the other of the isocyanate groups has formed an isocyanurate form together with two molecules of hexamethylene diisocyanate and tolylene diisocyanate, and an isocyanurate condensate of isophorone diisocyanate.

The amount of the polyisocyanate compound used is usually 1 to 30% by weight relative to 100% by weight of the whole amount of the microcapsule.

Examples of the polyol compound include ethylene glycol, propylene glycol, butylene glycol, polyoxyalkylenepolyol and cyclopropylene glycol.

The amount of the polyol compound used is usually 5 to 50% by weight relative to 100% by weight of the polyisocyanate compound.

Examples of the polyamine compound include ethylenediamine, hexamethylenediamine, diethylenetriamine, polyoxyalkylenepolyamine and triethylenetetramine.

The amount of the polyamine compound used is usually 5 to 50% by weight relative to 100% by weight of the polyisocyanate compound.

The shell of the microcapsule of the present invention can usually be produced by forming a shell material by polymerizing two or more kinds of monomer.

The microcapsule of the present invention can usually be produced by mixing a monomer and a core material to obtain an oil phase, obtaining a water phase containing another monomer capable of polymerizing with the aforementioned monomer to form a shell material, dispersing the oil phase in the water phase to obtain an oil droplet dispersion, and allowing the monomers to polymerize at the interfaces between the droplets and the water phase and thereby forming a shell material.

One example of the method of producing a microcapsule in the present invention wherein a hydrophobic liquid is used and the shell material for forming a shell is polyurethane resin is described below.

A hydrophobic liquid containing a fungicidal active ingredient and a polyisocyanate compound and an aqueous solution containing a polyol compound and an ordinary dispersing agent are fed to a stirring type disperser to prepare a first oil droplet dispersion. Subsequently, the first oil droplet dispersion obtained is fed to a stationary disperser to prepare a second oil droplet dispersion. Then, the second oil droplet dispersion is heated usually at 40 to 80° C., preferably at 60 to 80° C. to form a shell of a microcapsule at the interface between water and oil of each oil droplet. Thus, a microcapsule of the present invention can be produced.

By dispersing microcapsules of the present invention in water, an aqueous suspension composition can be produced.

The aqueous suspension composition of the present invention contains microcapsules of the present invention and water. The content of the microcapsules of the present invention in the aqueous suspension composition of the present invention is usually within the range of 1 to 50% by weight and the content of water is usually within the range of 50 to 99% by weight.

The aqueous suspension composition of the present invention optionally contains a dispersing agent, a defoaming agent, a thickener, a preservative agent, and an antifreezing agent, if necessary.

Examples of the dispersing agent include natural polysaccharides, such as gum arabic, natural water-soluble polymers, such as gelatin and collagen, water-soluble semisynthesis polysaccharides, such as carboxymethylcellulose, methylcellulose, and hydroxypropylcellulose, and water-soluble synthetic polymers, such as polyvinyl alcohol and polyvinylpyrrolidone.

When the aqueous suspension composition of the present invention contains a dispersing agent, the content of the dispersing agent in the aqueous suspension composition of the present invention is usually within the range of 0.5 to 10% by weight.

Specific examples of the defoaming agent include silicon-based defoaming agents, such as Antifoam C (produced by Dow Corning Corporation), Antifoam C Emulsion (produced by Dow Corning Corporation), Rhodorsil 454 (produced by Rhodia), Rhodorsil Antifoam 432 (produced by Rhodia), TSA730 (produced by Toshiba SiliconeCo., Ltd.) TSA731 (produced by Toshiba Silicone Co., Ltd.), TSA732 (produced by Toshiba Silicone Co., Ltd.), and YMA6509 (produced by Toshiba Silicone Co., Ltd.), and fluorine-based defoaming agents, such as Fluowet PL 80 (produced by Clariant).

The content of the defoaming agent in the aqueous suspension composition of the present invention is usually within the range of 0 to 1% by weight.

Examples of the thickener include natural polysaccharides, such as xanthan gum, rhamsan gum, locust bean gum, carrageenan and werant gum, synthetic polymers such as sodium polyacrylate, semisynthetic polysaccharides such as carboxymethylcellulose, mineral fine powders such as aluminum magnesium silicate, smectite, bentonite, hectorite and dry process silica, and alumina sols.

The content of the thickener in the aqueous suspension composition of the present invention is usually within the range of 0 to 10% by weight.

Examples of the preservative agent include p-hydroxybenzoic acid esters, salicylic acid derivatives, and isothiazolin-3-one derivatives.

The content of the preservative agent in the aqueous suspension composition of the present invention is usually within the range of 0 to 5% by weight.

Examples of the antifreezing agent include water-miscible monoalcohols, such as propanol, and water-miscible diols, such as ethylene glycol and propylene glycol.

The content of the antifreezing agent in the aqueous suspension composition of the present invention is usually within the range of 0 to 10% by weight.

Microcapsule-attached seeds can be produced by applying microcapsules of the present invention to seeds. The microcapsule-attached seeds can be produced by applying the aqueous suspension composition of the present invention or a water dilution thereof to seeds and then drying the seeds. Examples of the method of application include a method using a stirring type seed treater (HEGE11, manufactured by WINTERSTEIGER). The microcapsule-attached seeds of the present invention can also be produced by dusting microcapsules of the present invention to seeds or by immersing seeds in the aqueous suspension composition of the present invention or a water dilution thereof and drying the seeds.

The amount of the microcapsules of the present invention to be attached to seeds, which may vary depending upon the amount of the fungicidal active ingredient contained in the microcapsules and the types of the fungicidal active ingredient and the seeds, is usually within the range of 1 to 1000 g relative to 100 kg of the seeds.

Examples of the seeds to which the microcapsules of the present invention can be attached include seeds of barley, wheat, corn, sweet corn, white dent corn, soybean, cotton, a rapeseed, green peas, and rice.

By sowing microcapsule-attached seeds of the present invention in the soil, diseases of grown crops can be controlled.

The microcapsule of the present invention can also be applied to a plant or a soil in which a plant grows. In this case, the aqueous suspension composition of the present invention, a dilution prepared by diluting the aqueous suspension composition of the present invention with water, and a granular composition comprising the microcapsule of the present invention can usually be used.

This granular composition can be produced by mixing the microcapsule of the present invention with a solid carrier, and so on.

Examples of the solid carrier include mineral carriers, vegetable carriers, and synthetic carriers.

Examples of the mineral carriers include kaolin minerals, such as kaolinite, dickite, nacrite, and halloysite, serpentine, such as talc, chrysotile, lizardite, antigorite, and amesite, smectite, such as sodium montmorillonite, calcium montmorillonite, and magnesium montmorillonite, smectite, such as saponite, hectorite, sauconite, and beidellite, mica, such as pyrophyllite, agalmatolite, muscovite, phengite, sericite, and illite, silica, such as cristobalite and quartz, hydrous magnesium silicate, such as attapulgite and sepiolite, calcium carbonate, such as dolomite and calcium carbonate fine powder, sulfate minerals such as gypsum, zeolite, tuff, vermiculite, laponite, pumice, diatomaceous earth, acid clay, and activated clay. Examples of the vegetable carriers include cellulose, chaff, flour, wood flour, starch, rice bran, wheat bran, and soybean flour. Examples of the synthetic carriers include wet process silica, dry process silica, calcined wet process silica, surface-modified silica, and modified starch (e.g. Pineflow produced by Matsutani Chemical Industry Co., Ltd.).

The granular composition of the present invention usually contains the microcapsule of the present invention in 0.1 to 50% by weight and usually contains a solid carrier in 50 to 99.9% by weight.

Examples of vegetables whose diseases can be controlled by the application of the microcapsule of the present invention include barley, wheat, corn, sweet corn, white dent corn, soybean, cotton, rapeseed, green peas, and rice.

### EXAMPLES

The present invention is described in more detail below by way of production examples and test examples, but the invention is not limited to the examples.

First, production examples are presented. The trade names indicated in the Production Examples are as follows.

Solvesso 200ND: aromatic hydrocarbon solvent (mainly containing alkylnaphthalene having 11 to 14 carbon atoms in total) [produced by ExxonMobil Chemical Company]

Hallcomid M-8-10: mixture of N, N-dimethyloctamide and N,N-dimethyldecanamide [produced by Stepan Company]

Ricsizer C-101: methyl O-acetylricinoleate [produced by Itoh Oil Chemicals Co., Ltd.]

Ricsizer C-88: vegetable oil type fatty acid ester [produced by Itoh Oil Chemicals Co., Ltd.]

Steposol ME: mixture of methyl oleate and methyl linolate [produced by Stepan Company]

Steposol ROE-W: canola oil methyl ester [produced by Stepan Company]

Desmodur L-75: adduct of tolylene diisocyanate to trimethylolpropane [produced by Sumika Bayer Urethane Co., Ltd.]

Jeffamine T-403: polyoxypropylene triamine [produced by Huntsman]

Arabiccol SS: gum arabic [produced by San-ei Yakuhin Boeki Co., Ltd.]

Gohsenol GH-17: poly(vinyl alcohol) [produced by The Nippon Synthetic Chemical Industry Co., Ltd.]

Antifoam C Emulsion: silicon-based defoaming agent [produced by Dow Corning Corporation]

Kelzan S: xanthan gum [produced by Kelco]

Veegum granules: aluminum magnesium silicate [produced by Vanderbilt Company, Inc.]

Proxel GXL: preservative agent [produced by Avecia]

Color Coat Red: colorant [produced by Becker Underwood Inc.]

T.K. autohomomixer: homogenizer [produced by Tokushu Kika Kogyo Co., Ltd.]

Mastersizer 2000: laser diffraction type particle size distribution analyzer [produced by Sysmex Corp.]

HEGE11: stirring type seed treater [produced by WINTERSTEIGER]

The particle diameter distribution of the microcapsules in each of the compositions obtained in production examples and comparative production examples was measured by using Mastermizer 2000. The result of this measurement and the shell thickness of a microcapsule are expressed by the following symbols.

D₁₀: 10% cumulative volume particle diameter of microcapsules (μm)

D₅₀: 50% cumulative volume particle diameter of microcapsules (μm)

D₉₀: 90% cumulative volume particle diameter of microcapsules (μm)

T: shell thickness of microcapsule (μm)

### Production Example 1

Tebuconazole (25.00 g), Solvesso 200ND (97.80 g), and Desmodur L-75 (4.89 g) were mixed at 60° C., whereby an oil phase was prepared in which tebuconazole was dissolved.

On the other hand, Arabiccol SS (10.22 g), Gohsenol GH-17 (4.89 g), Antifoam C Emulsion (1.02 g), ethylene glycol (0.47 g), and ion exchange water (160.46 g) were mixed, whereby an aqueous phase was prepared.

The above-mentioned oil phase and aqueous phase were mixed. The resulting mixture was agitated using a T.K. autohomomixer at 60° C., whereby an oil droplet dispersion was obtained. The oil droplet dispersion was stirred gently at 60° C. for 24 hours, whereby a microcapsule dispersion was obtained.

Kelzan S (0.73 g), Veegum granules (1.47 g), Proxel GXL (0.98 g), propylene glycol (24.45 g), and ion exchange water (156.62 g) were mixed, whereby a thickener solution was prepared. This thickener solution and the above-mentioned microcapsule dispersion were mixed, whereby the present composition 1 was obtained.

D₁₀: 0.7 μm

D₅₀: 4.0 μm

D₉₀: 7.6 μm

T: 0.018 μm

D₅₀/T: 222

(D₉₀−D₁₀)/D₅₀: 1.73

### Production Example 2

Tebuconazole (25.00 g), Solvesso 200ND (97.80 g), and Desmodur L-75 (14.67 g) were mixed at 60° C., whereby an oil phase was prepared in which tebuconazole was dissolved.

On the other hand, Arabiccol SS (11.00 g), Gohsenol GH-17 (4.89 g), Antifoam C Emulsion (1.10 g), ethylene glycol (1.40 g), and ion exchange water (169.38 g) were mixed, whereby an aqueous phase was prepared.

The above-mentioned oil phase and aqueous phase were mixed. The resulting mixture was agitated using a T.K. autohomomixer at 60° C., whereby an oil droplet dispersion was obtained. The oil droplet dispersion was stirred gently at 60° C. for 24 hours, whereby a microcapsule dispersion was obtained.

Kelzan S (0.73 g), Veegum granules (1.47 g), Proxel GXL (0.98 g), propylene glycol (24.45 g), and ion exchange water (136.13 g) were mixed, whereby a thickener solution was prepared. This thickener solution and the above-mentioned microcapsule dispersion were mixed, whereby the present composition 2 was obtained.

D₁₀: 14.5 μm

D₅₀: 31.2 μm

D₉₀: 56.1 μm

T: 0.408 μm

D₅₀/T: 76

(D₉₀−D₁₀)/D₅₀: 1.33

### Production Example 3

Tebuconazole (25.00 g), Solvesso 200ND (97.80 g), and Desmodur L-75 (24.45 g) were mixed at 60° C., whereby an oil phase was prepared in which tebuconazole was dissolved.

On the other hand, Arabiccol SS (11.78 g), Gohsenol GH-17 (4.89 g), Antifoam C Emulsion (1.18 g), ethylene glycol (2.34 g), and ion exchange water (178.30 g) were mixed, whereby an aqueous phase was prepared.

The above-mentioned oil phase and aqueous phase were mixed. The resulting mixture was agitated using a T.K. autohomomixer at 60° C., whereby an oil droplet dispersion was obtained. The oil droplet dispersion was stirred gently at 60° C. for 24 hours, whereby a microcapsule dispersion was obtained.

Kelzan S (0.73 g), Veegum granules (1.47 g), Proxel GXL (0.98 g), propylene glycol (24.45 g), and ion exchange water (115.63 g) were mixed, whereby a thickener solution was prepared. This thickener solution and the above-mentioned microcapsule dispersion were mixed, whereby the present composition 3 was obtained.

D₁₀: 0.7 μm

D₅₀: 3.8 μm

D₉₀: 7.9 μm

T: 0.081 μm

D₅₀/T: 47

(D₉₀−D₁₀)/D₅₀: 1.89

### Production Example 4

Tebuconazole (50.00 g) and Ricsizer C-101 (97.80 g) were mixed and then the tebuconazole was milled with glass beads, whereby an oil slurry in which the tebuconazole was dispersed was obtained. Desmodur L-75 (24.45 g) was added to this oil slurry, whereby an oil phase was prepared.

On the other hand, Arabiccol SS (11.82 g), Gohsenol GH-17 (4.89 g), Antifoam C Emulsion (1.18 g), ethylene glycol (2.34 g), and ion exchange water (178.80 g) were mixed, whereby an aqueous phase was prepared.

The above-mentioned oil phase and aqueous phase were mixed. The resulting mixture was agitated using a T.K. autohomomixer, whereby an oil droplet dispersion was obtained. The oil droplet dispersion was stirred gently at 60° C. for 24 hours, whereby a microcapsule dispersion was obtained.

Kelzan S (0.73 g), Veegum granules (1.47 g), Proxel GXL (0.98 g), propylene glycol (24.45 g), and ion exchange water (90.08 g) were mixed, whereby a thickener solution was prepared. This thickener solution and the above-mentioned microcapsule dispersion were mixed, whereby the present composition 4 was obtained.

D₁₀: 1.4 μm

D₅₀: 9.5 μm

D₉₀: 19.7 μm

T: 0.168 μm

D₅₀/T: 57

(D₉₀−D₁₀)/D₅₀: 1.93

### Production Example 5

Tebuconazole (50.00 g) and Ricsizer C-101 (97.80 g) were mixed and then the tebuconazole was milled with glass beads, whereby an oil slurry in which the tebuconazole was dispersed was obtained. Desmodur L-75 (24.45 g) was added to this oil slurry, whereby an oil phase was prepared.

On the other hand, Arabiccol SS (11.82 g), Gohsenol GH-17 (4.89 g), Antifoam C Emulsion (1.18 g), diethylenetriamine (2.60 g), and ion exchange water (178.80 g) were mixed, whereby an aqueous phase was prepared.

The above-mentioned oil phase and aqueous phase were mixed. The resulting mixture was agitated using a T.K. autohomomixer, whereby an oil droplet dispersion was obtained. The oil droplet dispersion was stirred gently at 60° C. for 24 hours, whereby a microcapsule dispersion was obtained.

Kelzan S (0.73 g), Veegum granules (1.47 g), Proxel GXL (0.98 g), propylene glycol (24.45 g), and ion exchange water (89.83 g) were mixed, whereby a thickener solution was prepared. This thickener solution and the above-mentioned microcapsule dispersion were mixed, whereby the present composition 5 was obtained.

D₁₀: 1.5 μm

D₅₀: 8.3 μm

D₉₀: 17.6 μm

T: 0.134 μm

D₅₀/T: 62

(D₉₀−D₁₀)/D₅₀: 1.94

### Production Example 6

Tebuconazole (50.00 g) and Ricsizer C-101 (97.80 g) were mixed and then the tebuconazole was milled with glass beads, whereby an oil slurry in which the tebuconazole was dispersed was obtained. Desmodur L-75 (48.90 g) was added to this oil slurry, whereby an oil phase was prepared.

On the other hand, Arabiccol SS (13.78 g), Gohsenol GH-17 (4.89 g), Antifoam C Emulsion (1.38 g), ethylene glycol (4.68 g), and ion exchange water (201.10 g) were mixed, whereby an aqueous phase was prepared.

The above-mentioned oil phase and aqueous phase were mixed. The resulting mixture was agitated using a T.K. autohomomixer, whereby an oil droplet dispersion was obtained. The oil droplet dispersion was stirred gently at 60° C. for 24 hours, whereby a microcapsule dispersion was obtained.

Kelzan S (0.37 g), Veegum granules (0.73 g), Proxel GXL (0.49 g), propylene glycol (12.23 g), and ion exchange water (52.66 g) were mixed, whereby a thickener solution was prepared. This thickener solution and the above-mentioned microcapsule dispersion were mixed, whereby the present composition 6 was obtained.

D₁₀: 1.5 μm

D₅₀: 10.3 μm

D₉₀: 22.6 μm

T: 0.350 μm

D₅₀/T: 29

(D₉₀−D₁₀)/D₅₀: 2.05

### Production Example 7

Water (3.0 g) was added to the present composition 1 (1.0 g), whereby a diluted liquid was obtained. By using HEGE11, seeds of wheat (50 g) were treated (3000 rpm, 30 seconds) with the diluted liquid (200 μl) and then dried at room temperature overnight, whereby treated seeds were obtained. Observation of the surface of a treated seed with a scanning electron microscope found unbroken microcapsules on the surface of the treated seed.

### Production Example 8

Water (3.5 g) was added to the present composition 4 (0.5 g), whereby a diluted liquid was obtained. By using HEGE11, seeds of wheat (50 g) were treated (3000 rpm, 30 seconds) with the diluted liquid (200 μl) and then dried at room temperature overnight, whereby treated seeds were obtained. Observation of the surface of a treated seed with a scanning electron microscope found unbroken microcapsules on the surface of the treated seed.

### Production Example 9

Water (3.5 g) was added to the present composition 5 (0.5 g), whereby a diluted liquid was obtained. By using HEGE11, seeds of wheat (50 g) were treated (3000 rpm, 30 seconds) with the diluted liquid (200 μl) and then dried at room temperature overnight, whereby treated seeds were obtained. Observation of the surface of a treated seed with a scanning electron microscope found unbroken microcapsules on the surface of the treated seed.

### Production Example 10

Water (3.5 g) was added to the present composition 6 (0.5 g), whereby a diluted liquid was obtained. By using HEGE11, seeds of wheat (50 g) were treated (3000 rpm, 30 seconds) with the diluted liquid (200 μl) and then dried at room temperature overnight, whereby treated seeds were obtained. Observation of the surface of a treated seed with a scanning electron microscope found unbroken microcapsules on the surface of the treated seed.

### Production Example 11

Tebuconazole (50.00 g) and Ricsizer C-88 (97.80 g) were mixed and then the tebuconazole was milled with glass beads, whereby an oil slurry in which the tebuconazole was dispersed was obtained. Desmodur L-75 (24.45 g) was added to this oil slurry, whereby an oil phase was prepared.

On the other hand, Arabiccol SS (11.82 g), Gohsenol GH-17 (4.89 g), Antifoam C Emulsion (1.18 g), ethylene glycol (2.41 g), and ion exchange water (178.80 g) were mixed, whereby an aqueous phase was prepared.

The above-mentioned oil phase and aqueous phase were mixed. The resulting mixture was agitated using a T.K. autohomomixer, whereby an oil droplet dispersion was obtained. The oil droplet dispersion was stirred gently at 60° C. for 24 hours, whereby a microcapsule dispersion was obtained.

Kelzan S (0.73 g), Veegum granules (1.47 g), Proxel GXL (0.98 g), propylene glycol (24.45 g), and ion exchange water (90.02 g) were mixed, whereby a thickener solution was prepared. This thickener solution and the above-mentioned microcapsule dispersion were mixed, whereby the present composition 11 was obtained.

D₁₀: 1.7 μm

D₅₀: 10.4 μm

D₉₀: 20.0 μm

T: 0.181 μm

D₅₀/T: 57

(D₉₀−D₁₀)/D₅₀: 1.76

### Production Example 12

Tebuconazole (50.00 g) and Steposol ME (97.80 g) were mixed and then the tebuconazole was milled with glass beads, whereby an oil slurry in which the tebuconazole was dispersed was obtained. Desmodur L-75 (24.45 g) was added to this oil slurry, whereby an oil phase was prepared.

On the other hand, Arabiccol SS (11.82 g), Gohsenol GH-17 (4.89 g), Antifoam C Emulsion (1.18 g), ethylene glycol (2.41 g), and ion exchange water (178.80 g) were mixed, whereby an aqueous phase was prepared.

The above-mentioned oil phase and aqueous phase were mixed. The resulting mixture was agitated using a T.K. autohomomixer, whereby an oil droplet dispersion was obtained. The oil droplet dispersion was stirred gently at 60° C. for 24 hours, whereby a microcapsule dispersion was obtained.

Kelzan S (0.73 g), Veegum granules (1.47 g), Proxel GXL (0.98 g), propylene glycol (24.45 g), and ion exchange water (90.02 g) were mixed, whereby a thickener solution was prepared. This thickener solution and the above-mentioned microcapsule dispersion were mixed, whereby the present composition 12 was obtained.

D₁₀: 1.4 μm

D₅₀: 8.5 μm

D₉₀: 16.0 μm

T: 0.144 μm

D₅₀/T: 59

(D₉₀−D₁₀)/D₅₀: 1.72

### Production Example 13

Tebuconazole (50.00 g) and Steposol ROE-W (97.80 g) were mixed and then the tebuconazole was milled with glass beads, whereby an oil slurry in which the tebuconazole was dispersed was obtained. Desmodur L-75 (24.45 g) was added to this oil slurry, whereby an oil phase was prepared.

On the other hand, Arabiccol SS (11.82 g), Gohsenol GH-17 (4.89 g), Antifoam C Emulsion (1.18 g), ethylene glycol (2.41 g), and ion exchange water (178.80 g) were mixed, whereby an aqueous phase was prepared.

The above-mentioned oil phase and aqueous phase were mixed. The resulting mixture was agitated using a T.K. autohomomixer, whereby an oil droplet dispersion was obtained. The oil droplet dispersion was stirred gently at 60° C. for 24 hours, whereby microcapsule dispersion was obtained.

Kelzan S (0.73 g), Veegum granules (1.47 g), Proxel GXL (0.98 g), propylene glycol (24.45 g), and ion exchange water (90.02 g) were mixed, whereby a thickener solution was prepared. This thickener solution and the above-mentioned microcapsule dispersion were mixed, whereby the present composition 13 was obtained.

D₁₀: 1.5 μm

D₅₀: 8.9 μm

D₉₀: 16.4 μm

T: 0.150 μm

D₅₀/T: 59

(D₉₀−D₁₀)/D₅₀: 1.67

### Production Example 14

Metconazole (25.00 g), Solvesso 200ND (49.26 g), Hallcomid M-8-10 (49.26 g) and Desmodur L-75 (24.63 g) were mixed, whereby an oil phase was prepared in which metconazole was dissolved.

On the other hand, Arabiccol SS (13.04 g), Gohsenol GH-17 (4.93 g), Antifoam C Emulsion (0.57 g), diethylene triamine (1.57 g), and ion exchange water (193.67 g) were mixed, whereby an aqueous phase was prepared.

The above-mentioned oil phase and aqueous phase were mixed. The resulting mixture was agitated using a T. K. autohomomixer at 60° C., whereby an oil droplet dispersion was obtained. The oil droplet dispersion was stirred gently at 60° C. for 24 hours, whereby microcapsule dispersion was obtained.

Kelzan S (0.49 g), Veegum granules (0.99 g), Proxel GXL (0.99 g), propylene glycol (24.63 g), and ion exchange water (103.55 g) were mixed, whereby a thickener solution was prepared. This thickener solution and the above-mentioned microcapsule dispersion were mixed, whereby the present composition 14 was obtained.

D₁₀: 1.2 μm

D₅₀: 9.6 μm

D₉₀: 16.5 μm

T: 0.194 μm

D₅₀/T: 49

(D₉₀−D₁₀)/D₅₀: 1.59

### Production Example 15

Metconazole (50.00 g) and Steposol ME (98.51 g) were mixed and then the metconazole was milled with glass beads, whereby an oil slurry in which the metconazole was dispersed was obtained. Desmodur L-75 (24.63 g) was added to this oil slurry, whereby an oil phase was prepared.

On the other hand, Gohsenol GH-17 (4.93 g), Antifoam C Emulsion (1.33 g), Jeffamine T-403 (6.16 g), and ion exchange water (196.51 g) were mixed, whereby an aqueous phase was prepared.

The above-mentioned oil phase and aqueous phase were mixed. The resulting mixture was agitated using a T.K. autohomomixer, whereby an oil droplet dispersion was obtained. The oil droplet dispersion was stirred gently at 60° C. for 24 hours, whereby a microcapsule dispersion was obtained.

Kelzan S (0.25 g), Veegum granules (0.49 g), Proxel GXL (0.99 g), propylene glycol (24.63 g), and ion exchange water (84.14 g) were mixed, whereby a thickener solution was prepared. This thickener solution and the above-mentioned microcapsule dispersion were mixed, whereby the present composition 15 was obtained.

D₁₀: 2.6 μm

D₅₀: 16 μm

D₉₀: 34.8 μm

T: 0.312 μm

D₅₀/T: 52

(D₉₀−D₁₀)/D₅₀: 2.00

### Production Example 16

Metconazole (50.00 g) and Steposol ROE-W (98.51 g) were mixed and then the metconazole was milled with glass beads, whereby an oil slurry in which the metconazole was dispersed was obtained. Desmodur L-75 (24.63 g) was added to this oil slurry, whereby an oil phase was prepared.

On the other hand, Arabiccol SS (11.30 g), Gohsenol GH-17 (4.93 g), Antifoam C Emulsion (0.53 g), ethylene glycol (2.36 g), and ion exchange water (173.70 g) were mixed, whereby an aqueous phase was prepared.

The above-mentioned oil phase and aqueous phase were mixed. The resulting mixture was agitated using a T.K. autohomomixer, whereby an oil droplet dispersion was obtained. The oil droplet dispersion was stirred gently at 60° C. for 24 hours, whereby a microcapsule dispersion was obtained.

Kelzan S (0.25 g), Veegum granules (0.49 g), Proxel GXL (0.99 g), propylene glycol (24.63 g), and ion exchange water (100.25 g) were mixed, whereby a thickener solution was prepared. This thickener solution and the above-mentioned microcapsule dispersion were mixed, whereby the present composition 16 was obtained.

D₁₀: 1.4 μm

D₅₀: 5.3 μm

D₉₀: 11.6 μm

T: 0.087 μm

D₅₀/T: 61

(D₉₀−D₁₀)/D₅₀: 1.92

### Production Example 17

Metconazole (50.00 g) and Steposol ROE-W (98.51 g) were mixed and then the metconazole was milled with glass beads, whereby an oil slurry in which the metconazole was dispersed was obtained. Desmodur L-75 (49.26 g) was added to this oil slurry, whereby an oil phase was prepared.

On the other hand, Arabiccol SS (13.46 g), Gohsenol GH-17 (4.93 g), Antifoam C Emulsion (0.58 g), ethylene glycol (4.71 g), and ion exchange water (198.57 g) were mixed, whereby an aqueous phase was prepared.

The above-mentioned oil phase and aqueous phase were mixed. The resulting mixture was agitated using a T.K. autohomomixer, whereby an oil droplet dispersion was obtained. The oil droplet dispersion was stirred gently at 60° C. for 24 hours, whereby a microcapsule dispersion was obtained.

Kelzan S (0.25 g), Veegum granules (0.49 g), Proxel GXL (0.99 g), propylene glycol (24.63 g), and ion exchange water (46.18 g) were mixed, whereby a thickener solution was prepared. This thickener solution and the above-mentioned microcapsule dispersion were mixed, whereby the present composition 17 was obtained.

D₁₀: 1.4 μm

D₅₀: 5.8 μm

D₉₀: 14.5 μm

T: 0.184 μm

D₅₀/T: 32

(D₉₀−D₁₀)/D₅₀: 2.26

### Production Example 18

Ethaboxam (25.00 g) and Ricsizer C-88 (124.38 g) were mixed and then the ethaboxam was milled with glass beads, whereby an oil slurry in which the ethaboxam was dispersed was obtained. Desmodur L-75 (24.88 g) was added to this oil slurry, whereby an oil phase was prepared.

On the other hand, Arabiccol SS (13.34 g), Gohsenol GH-17 (4.98 g), Antifoam C Emulsion (1.33 g), ethylene glycol (2.38 g), and ion exchange water (196.90 g) were mixed, whereby an aqueous phase was prepared.

The above-mentioned oil phase and aqueous phase were mixed. The resulting mixture was agitated using a T.K. autohomomixer, whereby an oil droplet dispersion was obtained. The oil droplet dispersion was stirred gently at 60° C. for 24 hours, whereby a microcapsule dispersion was obtained.

Kelzan S (0.25 g), Veegum granules (0.50 g), Proxel GXL (1.00 g), propylene glycol (24.88 g), and ion exchange water (77.70 g) were mixed, whereby a thickener solution was prepared. This thickener solution and the above-mentioned microcapsule dispersion were mixed, whereby the present composition 18 was obtained.

D₁₀: 18.7 μm

D₅₀: 36.3 μm

D₉₀: 62.7 μm

T: 0.614 μm

D₅₀/T: 59

(D₉₀−D₁₀)/D₅₀: 1.21

### Production Example 19

Ethaboxam (25.00 g) and Steposol ROE-W (99.50 g) were mixed and then the ethaboxam was milled with glass beads, whereby an oil slurry in which the ethaboxam was dispersed was obtained. Desmodur L-75 (24.88 g) was added to this oil slurry, whereby an oil phase was prepared.

On the other hand, Arabiccol SS (9.73 g), Gohsenol GH-17 (4.98 g), Antifoam C Emulsion (0.49 g), ethylene glycol (2.38 g), and ion exchange water (156.21 g) were mixed, whereby an aqueous phase was prepared.

The above-mentioned oil phase and aqueous phase were mixed. The resulting mixture was agitated using a T.K. autohomomixer, whereby an oil droplet dispersion was obtained. The oil droplet dispersion was stirred gently at 60° C. for 24 hours, whereby a microcapsule dispersion was obtained.

Kelzan S (0.75 g), Veegum granules (1.49 g), Proxel GXL (1.00 g), propylene glycol (24.88 g), and ion exchange water (146.22 g) were mixed, whereby a thickener solution was prepared. This thickener solution and the above-mentioned microcapsule dispersion were mixed, whereby the present composition 19 was obtained.

D₁₀: 1.9 μm

D₅₀: 11.5 μm

D₉₀: 21.6 μm

T: 0.223 μm

D₅₀/T: 52

(D₉₀−D₁₀)/D₅₀: 1.71

### Production Example 20

Ethaboxam (25.00 g) and Steposol ROE-W (99.50 g) were mixed and then the ethaboxam was milled with glass beads, whereby an oil slurry in which the ethaboxam was dispersed was obtained. Desmodur L-75 (49.75 g) was added to this oil slurry, whereby an oil phase was prepared.

On the other hand, Arabiccol SS (11.35 g), Gohsenol GH-17 (4.98 g), Antifoam C Emulsion (0.53 g), ethylene glycol (4.76 g), and ion exchange water (174.81 g) were mixed, whereby an aqueous phase was prepared.

The above-mentioned oil phase and aqueous phase were mixed. The resulting mixture was agitated using a T.K. autohomomixer, whereby an oil droplet dispersion was obtained. The oil droplet dispersion was stirred gently at 60° C. for 24 hours, whereby a microcapsule dispersion was obtained.

Kelzan S (0.75 g), Veegum granules (1.49 g), Proxel GXL (1.00 g), propylene glycol (24.88 g), and ion exchange water (98.71 g) were mixed, whereby a thickener solution was prepared. This thickener solution and the above-mentioned microcapsule dispersion were mixed, whereby the present composition 20 was obtained.

D₁₀: 1.6 μm

D₅₀: 7.2 μm

D₉₀: 14.7 μm

T: 0.265 μm

D₅₀/T: 27

(D₉₀−D₁₀)/D₅₀: 1.82

### Production Example 21

Water (9.0 g) was added to the present composition 11 (1.0 g), whereby a diluted liquid was obtained. By using HEGE11, seeds of soybean (50 g) were treated (3000 rpm, 30 seconds) with the diluted liquid (250 μl) and then dried at room temperature overnight, whereby treated seeds were obtained. Observation of the surface of a treated seed with a scanning electron microscope found unbroken microcapsules on the surface of the treated seed.

### Production Example 22

Water (9.0 g) was added to the present composition 12 (1.0 g), whereby a diluted liquid was obtained. By using HEGE11, seeds of soybean (50 g) were treated (3000 rpm, 30 seconds) with the diluted liquid (250 μl) and then dried at room temperature overnight, whereby treated seeds were obtained. Observation of the surface of a treated seed with a scanning electron microscope found unbroken microcapsules on the surface of the treated seed.

### Production Example 23

Water (9.0 g) was added to the present composition 13 (1.0 g), whereby a diluted liquid was obtained. By using HEGE11, seeds of soybean (50 g) were treated (3000 rpm, 30 seconds) with the diluted liquid (250 μl) and then dried at room temperature overnight, whereby treated seeds were obtained. Observation of the surface of a treated seed with a scanning electron microscope found unbroken microcapsules on the surface of the treated seed.

### Production Example 24

Color Coat Red (0.25 g) and water (3.75 g) were added to the present composition 14 (1.0 g), whereby a diluted liquid was obtained. By using HEGE11, seeds of white dent corn (50 g) were treated (3000 rpm, 30 seconds) with the diluted liquid (500 μl) and then dried at room temperature overnight, whereby treated seeds were obtained. Observation of the surface of a treated seed with a scanning electron microscope found unbroken microcapsules on the surface of the treated seed.

### Production Example 25

Color Coat Red (0.5 g) and water (8.5 g) were added to the present composition 16 (1.0 g), whereby a diluted liquid was obtained. By using HEGE11, seeds of white dent corn (50 g) were treated (3000 rpm, 30 seconds) with the diluted liquid (500 μl) and then dried at room temperature overnight, whereby treated seeds were obtained. Observation of the surface of a treated seed with a scanning electron microscope found unbroken microcapsules on the surface of the treated seed.

### Production Example 26

Color Coat Red (0.5 g) and water (8.5 g) were added to the present composition 17 (1.0 g), whereby a diluted liquid was obtained. By using HEGE11, seeds of white dent corn (50 g) were treated (3000 rpm, 30 seconds) with the diluted liquid (500 μl) and then dried at room temperature overnight, whereby treated seeds were obtained. Observation of the surface of a treated seed with a scanning electron microscope found unbroken microcapsules on the surface of the treated seed.

### Production Example 27

Water (4.0 g) was added to the present composition 18 (1.0 g), whereby a diluted liquid was obtained. By using HEGE11, seeds of soybean (50 g) were treated (3000 rpm, 30 seconds) with the diluted liquid (250 μl) and then dried at room temperature overnight, whereby treated seeds were obtained. Observation of the surface of a treated seed with a scanning electron microscope found unbroken microcapsules on the surface of the treated seed.

### Production Example 28

Water (4.0 g) was added to the present composition 19 (1.0 g), whereby a diluted liquid was obtained. By using HEGE11, seeds of soybean (50 g) were treated (3000 rpm, 30 seconds) with the diluted liquid (250 μl) and then dried at room temperature overnight, whereby treated seeds were obtained. Observation of the surface of a treated seed with a scanning electron microscope found unbroken microcapsules on the surface of the treated seed.

### Comparative Production Example 1

Tebuconazole (25.00 g) and Ricsizer C-101 (97.80 g) were mixed and then the tebuconazole was milled with glass beads, whereby an oil slurry in which the tebuconazole was dispersed was obtained. Desmodur L-75 (4.89 g) was added to this oil slurry, whereby an oil phase was prepared.

On the other hand, Arabiccol SS (10.22 g), Gohsenol GH-17 (4.89 g), Antifoam C Emulsion (1.02 g), ethylene glycol (0.47 g), and ion exchange water (160.46 g), whereby an aqueous phase was prepared.

The above-mentioned oil phase and aqueous phase were mixed. The resulting mixture was agitated using a T.K. autohomomixer, whereby an oil droplet dispersion was obtained. The oil droplet dispersion was stirred gently at 60° C. for 24 hours, whereby a microcapsule dispersion was obtained.

Kelzan S (0.73 g), Veegum granules (1.47 g), Proxel GXL (0.98 g), propylene glycol (24.45 g), and ion exchange water (156.62 g) were mixed, whereby a thickener solution was prepared. This thickener solution and the above-mentioned microcapsule dispersion were mixed, whereby comparative composition 1 was obtained.

D₁₀: 3.3 μm

D₅₀: 18.6 μm

D₉₀: 33.8 μm

T: 0.079 μm

D₅₀/T: 235

(D₉₀−D₁₀)/D₅₀: 1.64

### Comparative Production Example 2

Tebuconazole (50.00 g) and Ricsizer C-101 (97.80 g) were mixed and then the tebuconazole was milled with glass beads, whereby an oil slurry in which the tebuconazole was dispersed was obtained. Desmodur L-75 (4.89 g) was added to this oil slurry, whereby an oil phase was prepared.

On the other hand, Arabiccol SS (10.26 g), Gohsenol GH-17 (4.89 g), Antifoam C Emulsion (1.03 g), ethylene glycol (0.47 g), and ion exchange water (160.96 g) were mixed, whereby an aqueous phase was prepared.

The above-mentioned oil phase and aqueous phase were mixed. The resulting mixture was agitated using a T.K. autohomomixer, whereby an oil droplet dispersion was obtained. The oil droplet dispersion was stirred gently at 60° C. for 24 hours, whereby a microcapsule dispersion was obtained.

Kelzan S (0.73 g), Veegum granules (1.47 g), Proxel GXL (0.98 g), propylene glycol (24.45 μm), and ion exchange water (131.07 g) were mixed, whereby a thickener solution was prepared. This thickener solution and the above-mentioned microcapsule dispersion were mixed, whereby comparative composition 2 was obtained.

D₁₀: 1.6 μm

D₅₀: 8.7 μm

D₉₀: 17.2 μm

T: 0.032 μm

D₅₀/T: 272

(D₉₀−D₁₀)/D₅₀: 1.79

### Comparative Production Example 3

Water (3.0 g) was added to comparative composition 1 (1.0 g), whereby a diluted liquid was obtained. By using HEGE11, seeds of wheat (50 g) were treated (3000 rpm, 30 seconds) with the diluted liquid (200 μl) and then dried at room temperature overnight, whereby treated seeds were obtained.

### Comparative Production Example 4

Water (3.5 g) was added to comparative composition 2 (0.5 g), whereby a diluted liquid was obtained. By using HEGE11, seeds of wheat (50 g) were treated (3000 rpm, 30 seconds) with the diluted liquid (200 μl) and then dried at room temperature overnight, whereby treated seeds were obtained.

Next, test examples are provided.

### Test Example 1

A prescribed amount of acetonitrile (with an internal standard) was added to the treated seeds obtained in a Production Example described above, followed by ultrasonic radiation, and thereby the tebuconazole attaching to the seeds was extracted. The extraction solution was filtered through a filter to prepare a sample solution for analysis. High performance liquid chromatography analysis was conducted using the sample solution to analyze the amount of tebuconazole and thereby the attachment rate of tebuconazole (=[measured amount of tebuconazole attaching to the seeds (mg)]/[theoretical amount of tebuconazole attaching to the seeds (mg)]×100(%)) of respective treated seeds was determined. Results are shown in Table 1.

TABLE 1

| | Attachment rate of tebuconazole (%) |
|---|---|
| Production Example 7 | 81 |
| Production Example 8 | 81 |
| Production Example 9 | 84 |
| Production Example 10 | 82 |
| Production Example 21 | 81 |
| Production Example 22 | 88 |
| Production Example 23 | 82 |
| Comparative | 55 |
| Production Example 3 | |
| Comparative | 17 |
| Production Example 4 | |

### Test Example 2

A prescribed amount of acetonitrile (with an internal standard) was added to the treated seeds obtained in a Production Example described above, followed by ultrasonic radiation, and thereby the metconazole attaching to the seeds was extracted. The extraction solution was filtered through a filter to prepare a sample solution for analysis. High performance liquid chromatography analysis was conducted using the sample solution to analyze the amount of metconazole and thereby the attachment rate of metconazole (=[measured amount of metconazole attaching to the seeds (mg)]/[theoretical amount of metconazole attaching to the seeds (mg)]×100(%)) of respective treated seeds was determined. Results are shown in Table 2.

TABLE 2

| | Attachment rate of metconazole (%) |
|---|---|
| Production Example 24 | 87 |
| Production Example 25 | 84 |
| Production Example 26 | 82 |

### Test Example 3

A prescribed amount of acetonitrile (with an internal standard) was added to the treated seeds obtained in a Production Example described above, followed by ultrasonic radiation, and thereby the ethaboxam attaching to the seeds was extracted. The extraction solution was filtered through a filter to prepare a sample solution for analysis. High performance liquid chromatography analysis was conducted using the sample solution to analyze the amount of ethaboxam and thereby the attachment rate of ethaboxam (=[measured amount of ethaboxam attaching to the seeds (mg)]/[theoretical amount of ethaboxam attaching to the seeds (mg)]×100(%)) of respective treated seeds was determined. Results are shown in Table 3.

TABLE 3

| | Attachment rate of ethaboxam (%) |
|---|---|
| Production Example 27 | 95 |
| Production Example 28 | 90 |

1. A microcapsule in which a core material containing a fungicidal active ingredient is enclosed within a shell material, wherein the microcapsule satisfies the following conditions (1) and (2):
D₅₀/T≦230 condition (1)
(D₉₀−D₁₀)/D₂₀≦2.5 condition (2)
wherein in the formulae of conditions (1) and (2), T represents the shell thickness (μm) of the microcapsule, D₁₀ represents the 10% cumulative volume particle diameter (μm) of the microcapsule, D₅₀ represents the 50% cumulative volume particle diameter (μm) of the microcapsule, and D₉₀ represents the 90% cumulative volume particle diameter (μm) of the microcapsule.

2. The microcapsule according to claim 1, wherein the fungicidal active ingredient is an azole compound.

3. The microcapsule according to claim 1, wherein the fungicidal active ingredient is tebuconazole.

4. The microcapsule according to claim 1, wherein the shell material is composed of a polyurethane resin and/or a polyurea resin.

5. The microcapsule according to claim 1, wherein the core material contains a hydrophobic liquid.

6. The microcapsule according to claim 5, wherein the fungicidal active ingredient is dissolved in the hydrophobic liquid.

7. The microcapsule according to claim 5, wherein the fungicidal active ingredient is dispersed in the hydrophobic liquid.

8. The microcapsule according to claim 1, wherein the condition (2) is (D₉₀−D₁₀)/D₅₀≦2.1

9. An aqueous suspension composition in which the microcapsule according to claim 1 is suspended in water.

10. A method for controlling plant disease, comprising applying the microcapsule according to claim 1 to a plant or a soil in which a plant grows.

11. A method for controlling plant disease, comprising treating the microcapsule according to claim 1 to a seed of a plant.

12. A seed with the microcapsule according to claim 1 attaching thereto.

13. A method for controlling plant disease, comprising the step of making the microcapsule according to claim 1 to attach to seeds of a plant before sowing the seeds.

14. A method for producing a microcapsule-attached seed, comprising the step of treating the microcapsule according to claim 1 to a seed.

15. The microcapsule according to claim 2, wherein the shell material is composed of a polyurethane resin and/or a polyurea resin.

16. The microcapsule according to claim 3, wherein the shell material is composed of a polyurethane resin and/or a polyurea resin.

17. The microcapsule according to claim 2, wherein the core material contains a hydrophobic liquid.

18. The microcapsule according to claim 3, wherein the core material contains a hydrophobic liquid.

19. The microcapsule according to claim 4, wherein the core material contains a hydrophobic liquid.

20. The microcapsule according to claim 2, wherein the condition (2) is (D₉₀−D₁₀)/D₅₀≦2.1
